(19) United States
(12) Patent Application Publication
(10) Pub. No.: US 2010/0050987 A1
(43) Pub. Date: Mar. 4, 2010

(54) INTERNAL COMBUSTION ENGINE CONTROL DEVICE

(75) Inventor: Fumihiko SATO, Susono-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/204,428

(22) Filed: Sep. 4, 2008

(51) Int. Cl. F02P 5/15

(52) U.S. Cl. 123/406.25; 123/406.52

(57) ABSTRACT

The present invention judges whether the amount of change in the accelerator opening is larger than a reference change amount. If the amount of change in the accelerator opening is found to be larger than the reference change amount, the present invention performs setup so that a throttle valve 32 has a large throttle opening, which is larger than a target opening that is set in accordance with an intake air amount necessary for generating a target torque. Further, the present invention performs ignition timing setup so as to generate the target torque at the large throttle opening.

### BACKGROUND OF THE INVENTION

1. Field of the Invention

The present invention relates to an internal combustion engine control device. More specifically, the present invention relates to a control device for an internal combustion engine having an ignition plug positioned in a cylinder and a throttle valve that can be controlled independently of an accelerator pedal operation amount.

2. Background Art

A control device disclosed in JP-A-3-182667 controls ignition timing and fuel injection amount during a transient operation of an internal combustion engine in accordance with torque to be actually generated. More specifically, this device first calculates a target torque in accordance with an accelerator operation amount. Next, the device determines an intake air amount necessary for generating the target torque, and preselects a throttle valve opening (throttle opening) in accordance with the intake air amount. Due to the volumetric capacity of an intake path positioned downstream of a throttle valve, however, the amount of air actually supplied into a cylinder differs from the amount of air passing through the throttle valve immediately after the throttle opening is changed to the preselected opening. More specifically, there is a response lag (phase lag) between the instant at which the throttle opening is changed in accordance with the intake air amount necessary for generating the target torque and the instant at which the resulting amount of air is actually supplied into the cylinder. Consequently, actual torque, which is actually generated, differs from the target torque.

To compensate for such a phase lag of the intake air amount, the conventional technology described above calculates the amount of air to be actually supplied into the cylinder before ignition timing and fuel injection amount determination, and calculates the actual torque, which is to be actually generated, in accordance with the calculated air amount. Subsequently, the above conventional technology determines an optimum fuel injection amount and optimum ignition timing in accordance with the actual torque. The above conventional technology exercises control in the above-described manner to compensate for the phase lag of the intake air amount, supply appropriate amounts of fuel and air to each cylinder even during a transient operation, and achieve ignition with optimum timing.

After the intake air amount is calculated in accordance with the target torque, however, the above conventional technology calculates the actual air amount whose phase lag is to be compensated for, calculates the actual torque from the actual air amount, and then determines the optimum fuel injection amount and ignition timing in accordance with the actual torque. This may increase control parameter computation load, thereby causing control lag. The control process described above determines the optimum ignition timing and fuel injection amount in accordance with the calculated actual torque, but does not compensate for the control lag between the target torque and actual torque, which is based on the phase lag of the intake air amount. In other words, it is difficult for the above conventional technology to immediately generate a necessary target torque in accordance with a request based on an accelerator operation amount.

### SUMMARY OF THE INVENTION

The present invention solves the above problem, and provides an improved internal combustion engine control device that is capable of reducing an air intake lag of the intake air amount and immediately generating a necessary torque even when the accelerator opening changes greatly to cause a considerable increase in the required torque.

According to one aspect of the present invention, an internal combustion engine control device comprises accelerator opening detector for detecting an accelerator opening and accelerator change judgment device. The accelerator judges whether a change in the accelerator opening is greater than a reference change amount. The control device comprises target torque calculator for calculating a target torque in accordance with the accelerator opening. The control device further comprises the change period throttle opening setup device and change period ignition timing setup device. The change period throttle opening setup device, sets a large throttle opening for a throttle valve positioned in an intake path of an internal combustion engine when a change in the accelerator opening is judged to be greater than the reference change amount. The large throttle opening is larger than a target opening that is selected in accordance with an intake air amount necessary for the generation of the target torque. The change and change period ignition timing setup device sets an ignition timing for an ignition plug positioned in a cylinder of the internal combustion engine, the ignition timing being agrees with the timing for generating the target torque while the large throttle opening is provided.

According to another aspect of the present invention, in the internal combustion engine control device, the change period throttle opening setup device may use the large throttle opening as a control maximum opening.

According to another aspect of the present invention, the internal combustion engine control device may include reference change amount setup device for setting the reference change amount in accordance with the accelerator opening.

According to another aspect of the present invention, the internal combustion engine control device may include accelerator continuation judgment device for judging whether the period of time during which the accelerator opening is larger than a reference opening is longer than reference time. The control device may include target opening setup device which, when the period of time during which the accelerator opening is larger than the reference opening is judged to be longer than the reference time, sets the target opening as the opening of the throttle valve. The control device may include target ignition timing setup device for setting a target ignition timing for generating the target torque while the target opening is provided.

According to another aspect of the present invention, the internal combustion engine control device may include air amount estimation device for estimating the amount of air to be actually supplied to the cylinder after the opening of the throttle valve is controlled to agree with the target opening. The control device may include ignition timing gradual change device for setting an ignition timing for generating the target torque while the estimated amount of air is supplied. The control device may include ignition timing advance judgment device for judging whether the set ignition timing has advanced to the target ignition timing. When the set ignition timing advances to the target ignition timing, the target ignition timing setup device may set the target ignition timing as the ignition timing.

According to another aspect of the present invention, the internal combustion engine control device may include ignition timing advance device which, after the opening of the throttle valve is controlled to agree with the target opening, sets an ignition timing that has advanced by a certain angle from the current ignition timing. The control device may include ignition timing advance judgment device for judging whether the advanced ignition timing has advanced to the target ignition timing. When the advanced ignition timing advances to the target ignition timing, the target ignition timing setup device may set the target ignition timing as the ignition timing.

According to another aspect of the present invention, the internal combustion engine control may include throttle opening controller for exercising control to obtain a preset opening of the throttle valve and ignition timing controller for exercising control to provide a preset ignition timing for the ignition plug.

According to another aspect of the present invention, an internal combustion engine control device comprises accelerator opening detection means for detecting an accelerator opening, accelerator change judgment means for judging whether a change in the accelerator opening is greater than a reference change amount, and target torque calculation means for calculating a target torque in accordance with the accelerator opening. The control device comprises change period throttle opening setup means and change period ignition timing setup means. When a change in the accelerator opening is judged to be greater than the reference change amount, the change period throttle opening setup means sets a large throttle opening for a throttle valve positioned in an intake path of an internal combustion engine, the large throttle opening being larger than a target opening that is selected in accordance with an intake air amount necessary for the generation of the target torque. The change period ignition timing setup means sets an ignition timing for an ignition plug positioned in a cylinder of the internal combustion engine, the ignition timing being agrees with the timing for generating the target torque while the large throttle opening is provided.

Other objects and further features of the present invention will be apparent from the following detailed description when read in conjunction with the accompanying drawings.

### BRIEF DESCRIPTION OF THE DRAWINGS

FIG. 1 is a schematic diagram illustrating the configuration of a control system for an internal combustion engine according to an embodiment of the present invention;

FIG. 2 is a graph illustrating the relationship between ignition timing, generated torque, and load factor;

FIG. 3 is a flowchart illustrating a control routine that is executed by the system according to an embodiment of the present invention.

### DETAILED DESCRIPTION OF THE PREFERRED EMBODIMENT

An embodiment of the present invention will now be described with reference to the accompanying drawings. Like elements in the drawings are designated by the same reference numerals and will be described in an abbreviated manner or will not be redundantly described.

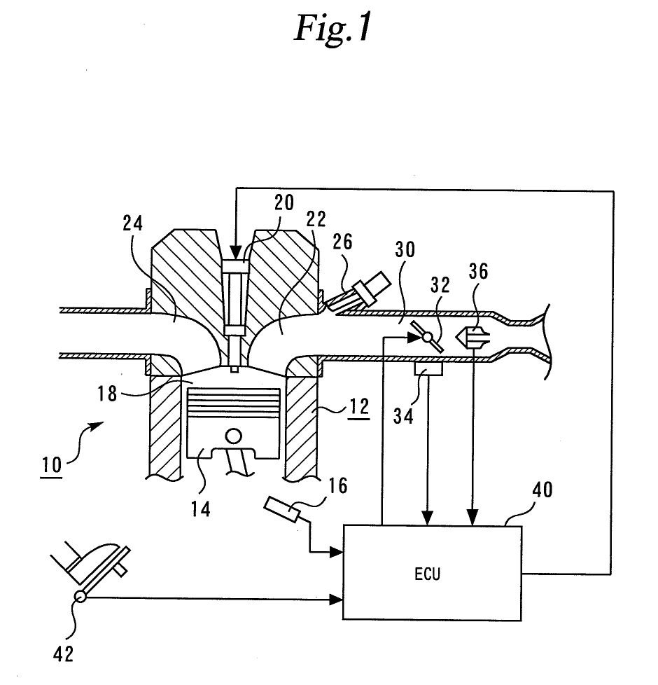

FIG. 1 is a schematic diagram illustrating the configuration of a control system for an internal combustion engine according to an embodiment of the present invention. The system shown in FIG. 1 includes an internal combustion engine 10. The internal combustion engine 10 includes a cylinder 12. Although FIG. 1 shows only a cross-section of one cylinder 12 for simplicity, the internal combustion engine 10 includes a plurality of cylinders 12 in reality. A piston 14 is positioned inside each cylinder 12. The piston 14 is connected to a crankshaft (not shown) via a connecting rod. A rotation speed sensor 16 is positioned near the crankshaft to generate an output according to the engine speed of the internal combustion engine 10.

A combustion chamber 18 is positioned over the piston 14 within the cylinder 12. An ignition plug 20 is attached to the center of the ceiling (cylinder head) of the combustion chamber 18 in such a manner that a gap at its leading end protrudes into the combustion chamber 18. The ceiling of the combustion chamber 18 communicates with an intake port 22 and an exhaust port 24. A port injector 26 is installed in the intake port 22 in such a manner that an injection tip at its leading end protrudes into the intake port 22.

A common intake path 30 is connected to the intake port 22 for each cylinder 12. The intake path 30 is provided with an electronically controlled throttle valve 32. The opening of the throttle valve 32 can be varied to adjust the amount of air flowing into the intake path 30. The opening of the throttle valve 32 (throttle opening) is electrically controlled via an actuator in accordance, for instance, with an acceleration/deceleration request based, for instance, on an accelerator operation. In other words, the throttle opening can be controlled without regard to the accelerator opening. A throttle opening sensor 34 is positioned near the throttle valve 32 to detect the throttle opening. An air flow meter 36 is installed in the intake path 30 and positioned upstream of the throttle valve 32. The air flow meter 36 generates an output according to the rate of air flow into the intake path 30.

The internal combustion engine 10 includes an ECU (Electronic Control Unit) 40. The ECU 40 acquires information required for controlling the internal combustion engine 10 from various sensors such as the rotation speed sensor 16, throttle opening sensor 34, air flow meter 36, and accelerator opening sensor 42. Further, the ECU 40 controls, for instance, the ignition timing of the ignition plug 20, the throttle opening, the amount of fuel injection from the port injector 26, and the timing of fuel injection in accordance with the acquired information.

In general, while an internal combustion engine is operating, a target torque required under current operating conditions is calculated in accordance with the accelerator opening and the engine speed. Further, an intake air amount necessary for generating the target torque is determined in accordance with the calculated target torque. Subsequently, a throttle opening appropriate for the intake air amount is set. The throttle opening is then controlled to regulate the intake air amount. In this instance, the ignition timing is set to an MBT (minimum advance for best torque) ignition timing that provides optimum fuel efficiency and output at the current intake air amount and engine speed.

Due to the volumetric capacity of the intake path 30 positioned downstream of the throttle valve 32, however, the amount of air actually taken into the cylinder 12 differs from the amount of air passing through the throttle valve 32 immediately after the throttle opening is changed. More specifically, there is an air intake lag between the instant at which the throttle opening is changed in accordance with the target torque and the instant at which the resulting amount of air, which is appropriate for the changed throttle opening, is actually supplied into the cylinder 12. Consequently, the actual torque, which is actually generated, differs from the target torque. Therefore, if the target torque is greatly increased, it is difficult to immediately generate a torque according to the increased target torque even when a throttle opening according to the intake air amount required for target torque generation is selected. Consequently, the response to a driver's request may become delayed.

To make it possible to immediately respond to an acceleration request or other torque increase request, therefore, the present embodiment exercises control to immediately provide a control maximum opening (wide open throttle or WOT) as the throttle opening without regard to the target torque when the amount of change in the accelerator opening ACC is larger than a reference change amount. In other words, the present embodiment exercises control to immediately provide WOT as the throttle opening without setting the throttle opening in accordance with a calculated intake air amount according to the target torque. This makes it possible to immediately control the throttle opening without imposing computation load for throttle opening calculation and take in the maximum possible amount of intake air. Therefore, even when the amount of increase in the target torque is large, it is possible to create a state where a necessary amount of intake air can be obtained immediately. Further, as the maximum amount of intake air corresponding to WOT can be introduced into the intake path 30, it is possible to increase the amount of air to be actually taken into the cylinder 12 at an earlier stage. As a result, the air intake lag can be minimized to allow a necessary amount of air or more than the necessary amount of air to be immediately taken into the cylinder 12.

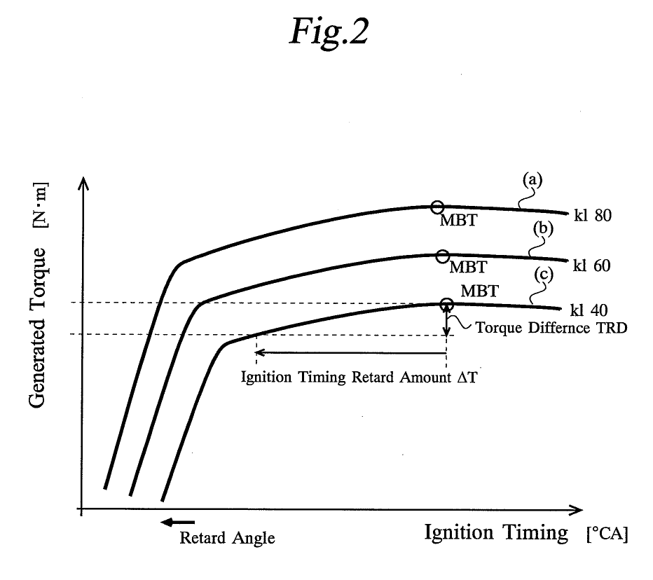

Meanwhile, when WOT is used as the throttle opening, it is conceivable that the amount of air supplied to the cylinder 12 may be larger than the air amount according to the target torque. Therefore, if an MBT ignition timing is selected while WOT is used as the throttle opening without regard to the target torque, the generated torque is greater than the target torque. Consequently, ignition timing control is exercised so that the generated torque agrees with the target torque. FIG. 2 is a graph illustrating the relationship between ignition timing, generated torque, and load factor. In FIG. 2, the horizontal axis represents ignition timing (° CA), whereas the vertical axis represents generated torque TR (N·m). Curves (a), (b), (c) in FIG. 2 represent cases where the load factor is 80%, 60%, and 40%, respectively.

As is obvious from FIG. 2, the MBT ignition timing is set so as to generate the maximum torque. FIG. 2 indicates that the generated torque decreases with an increase in the retard of the ignition timing from MBT. This relationship can be used to determine an ignition timing retard amount required for generating a torque that is smaller by a predetermined amount than the torque to be generated when the ignition timing is MBT. More specifically, it is possible to determine an ignition timing retard amount ΔT required for offsetting the torque difference TRD between the target torque TRtg and the maximum torque TRmax provided when the throttle opening is WOT and the ignition timing is MBT, and for decreasing the generated torque to the target torque TRtg. In the present embodiment, the ignition timing Twot for a case where control is exercised to provide WOT as throttle opening is set to a timing that is obtained by retarding the MBT in accordance with the determined ignition timing retard amount ΔT. As a result, a torque corresponding to the target torque TRtg can be generated even when the throttle opening is WOT.

The system according to the present embodiment stores in advance a map that is obtained in accordance with the relationship shown in FIG. 2 and uses the torque difference TRD (TRmax−TRtg) and load factor as parameters. Therefore, the ignition timing retard amount ΔT based on the torque difference TRD and load factor is determined in accordance with the map. Further, the ignition timing Twot is determined by retarding the MBT ignition timing accordingly.

Ignition timing control is exercised by controlling the ignition plug 20, which is installed in the cylinder 12, in accordance with a control signal supplied from the ECU 40. Therefore, the ignition timing can be immediately controlled in accordance with the determined ignition timing Twot. Consequently, when the accelerator opening is increased, control can be exercised in accordance with an acceleration request to immediately acquire a necessary amount of intake air and generate a necessary torque by immediately setting the throttle opening to WOT to create a state where the maximum amount of intake air is taken in and regulating the generated toque by exercising retard control over the ignition timing.

The amount of target torque change relative to the accelerator opening change is large when the accelerator opening is small and small when the accelerator opening is large. Therefore, it is used as a criterion for judging whether control should be exercised to retard the ignition timing with the throttle opening set to WOT. The present embodiment sets the reference change amount as a value according to the accelerator opening. It is assumed that the system according to the present embodiment stores in advance a reference change amount map that uses the accelerator opening ACC as a parameter.

As described above, the MBT ignition timing is set as an ignition timing that provides the optimum output and fuel efficiency under its intake air amount, engine speed NE, and other conditions. In other words, when control is exercised to generate the target torque by retarding the ignition timing from MBT while the intake air amount for the WOT throttle opening is provided, the resulting torque loss and fuel consumption are greater than when an operation is conducted with the MBT ignition timing. Further, the exhaust temperature may be high due to the retarded ignition timing. Therefore, control exercised to generate the target torque by using the above-mentioned WOT throttle opening and retarding the ignition timing is effective in a situation where the amount of increase in the accelerator opening ACC is large and an immediate response is requested. For fuel efficiency improvement, however, it is preferred that switching be promptly effected to initiate control for using the MBT ignition timing while a normal throttle opening is employed.

Therefore, if the accelerator opening ACC is larger than the reference opening for a predetermined period or longer, operating conditions are changed to employ the target opening according to the target torque as the throttle opening and use the MBT ignition timing. More specifically, when it is assumed that the ignition timing is MBT, the target opening is determined in accordance with an intake air amount that is required for generating the target torque, and the throttle opening is immediately changed from WOT to the target opening.

When the throttle opening is set to the target opening as described above, it is necessary to advance the ignition timing from a retarded state to MBT. However, an air intake lag occurs between a change in the throttle opening and a change in the amount of air actually taken into the cylinder 12. More specifically, even when the throttle opening is drastically changed from WOT to the target opening, the change in the amount of air actually taken into the cylinder 12 is gradual. Immediately after the throttle opening change, therefore, the amount of air actually supplied into the cylinder 12 is larger than an intake air amount according to the target opening. Consequently, if switching is effected to use the MBT ignition timing immediately, it is conceivable that the generated torque may be greater than the target torque. As a result, torque fluctuations may occur at the time of switching. To avoid torque fluctuations upon switching, therefore, it is preferred that the ignition timing be controlled in accordance with the amount of air actually supplied into the cylinder 12 to avoid torque fluctuations during the time interval between the instant at which the throttle opening is changed and the instant at which an amount of intake air according to the target torque is actually supplied into the cylinder 12.

The change that occurs in the air amount during the time interval between the instant at which the throttle opening is changed and the instant at which the amount of air actually supplied to the cylinder 12 reaches the air amount according to the throttle opening can be predicted with certain accuracy in accordance, for instance, with the engine speed NE, intake air temperature, atmospheric pressure, and throttle opening. Therefore, the present embodiment sets the ignition timing prevailing after a throttle opening change so as to avoid a change in the generated torque in accordance with an estimated amount of air GAs actually supplied into the cylinder 12. The estimated air amount GAs gradually decreases during the interval between the instant at which the maximum amount of intake air according to the WOT throttle opening is taken in and the instant at which the target intake air amount according to the target opening is reached. When the air amount GAs decreases, the ignition timing gradually advances from a retarded state according to the WOT throttle opening. When the estimated air amount GAs eventually agrees with the target intake air amount, it is considered that the ignition timing has advanced to MBT. Therefore, the sequence for retarding the ignition timing terminates when the ignition timing is MBT.

Ignition timing control is provided by the ECU 40, which directly controls the ignition plug 20 positioned in the cylinder 12. Thus, control can be immediately exercised in accordance with predefined ignition timing. Therefore, an intake air amount causing an air intake lag is controlled to bring about a prompt change by drastically changing the throttle opening from WOT to the target opening. Meanwhile, a torque change arising out of a change in the intake air amount can be suppressed by controlling the ignition timing, which can be promptly controlled. More specifically, when the throttle opening is drastically changed to control the ignition timing, it is possible to switch to a fuel-efficient operation at an earlier stage while suppressing a torque change.

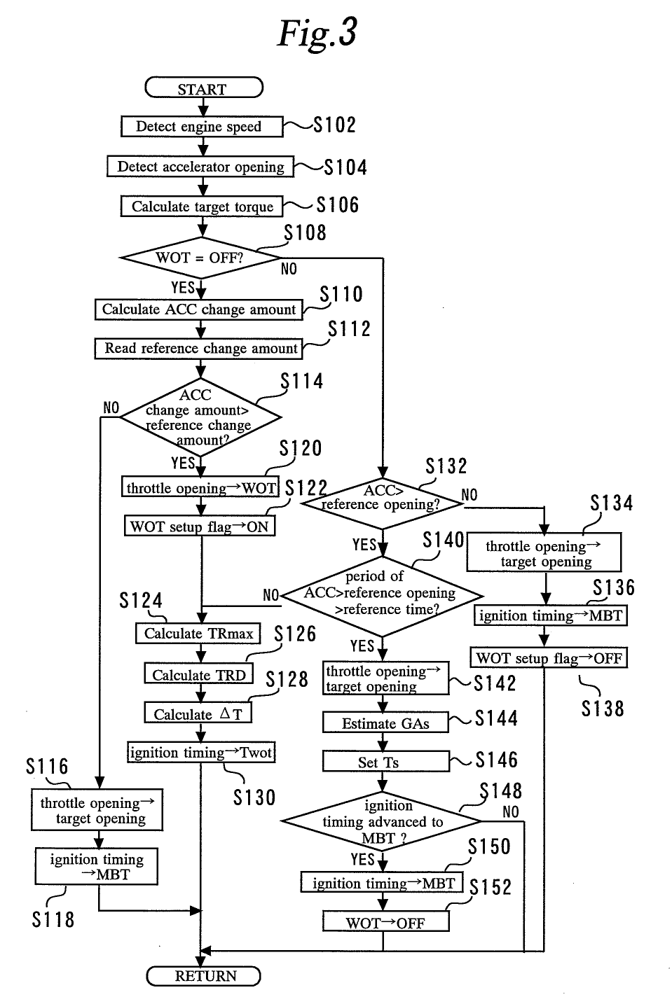

FIG. 3 is a flowchart illustrating a control routine that is executed by the system according to an embodiment of the present invention. The routine shown in FIG. 3 is repeatedly executed for ignition timing setup. In the flowchart shown in FIG. 3, step S102 is performed first to detect the engine speed NE. The engine speed NE is detected in accordance with an output from the rotation speed sensor 16. Next, step S104 is performed to detect the accelerator opening ACC. Step S106 is then performed to calculate the target torque TRtg. The target torque TRtg is determined in accordance, for instance, with the engine speed NE and accelerator opening ACC.

Next, step S108 is performed to judge whether a WOT setup flag is OFF. The WOT setup flag turns ON when the throttle opening is set to WOT during a later-described control sequence. If the judgment result obtained in step S108 indicates that the WOT setup flag is OFF, step S110 is performed to calculate an accelerator opening change amount. The difference between the accelerator opening ACC detected in step S104 and the previously detected accelerator opening is determined as the accelerator opening change amount. Next, step S112 is performed to read the reference change amount. The map using the accelerator opening as a parameter is viewed to read the reference change amount in accordance with the accelerator opening ACC detected in step S104.

Next, step S114 is performed to judge whether the amount of increase in the accelerator opening ACC is larger than the reference change amount. In other words, step S114 is performed to judge whether a great increase in the target torque is requested. If the judgment result obtained in step S114 does not indicate that the amount of increase in the accelerator opening ACC is larger than the reference change amount, step S116 is performed to set the throttle opening to a target opening according to the amount of intake air necessary for generating the target torque TRtg determined in step S106. In other words, the target opening is set in accordance with an intake air amount that is determined from the engine speed NE and target torque TRtg. The target opening is a throttle opening according to an intake air amount necessary for generating the target torque TRtg with MBT ignition timing at the engine speed NE. Therefore, step S118 is subsequently performed to set the ignition timing to MBT. The routine then comes temporarily to an end.

If, on the other hand, the judgment result obtained in step S114 indicates that the amount of increase in the accelerator opening ACC is larger than the reference change amount, step S120 is performed to exercise control so that the throttle opening is immediately WOT. More specifically, the ECU 40 transmits a control signal to an actuator to place the throttle valve 32 in the control maximum opening state (fully open the throttle valve 32). The maximum amount of air that can be immediately taken in then flows in the intake path 30. Next, step S122 is performed to turn ON the WOT setup flag. The WOT setup flag remains ON while control is exercised to use a WOT throttle opening.

Next, step S124 is performed to calculate the torque TRmax that is generated under the current operating conditions if it is assumed that the ignition timing is MBT. The torque TRmax is generated when ignition is performed with MBT timing for generating an optimum output at an intake air amount and engine speed NE that prevail when the throttle opening is WOT. Next, step S126 is performed to determine the torque difference TRD between the torque TRmax at MBT and the target torque TRtg calculated in step S106. In other words, the torque difference TRD=TRmax−TRtg. Next, step S128 is performed to calculate the ignition timing retard amount ΔT. The ignition timing retard amount ΔT is the amount of retard from MBT that is necessary for offsetting the torque difference TRD, and determined from the torque difference TRD and load factor in accordance with a map that uses the torque difference TRD and load factor as parameters. Next, step S130 is performed to set the ignition timing Twot. The ignition timing Twot is set by retarding the MBT ignition timing in accordance with the calculated ignition timing retard amount. Subsequently, this process terminates temporarily.

If, on the other hand, the judgment result obtained in step S108 does not indicate that the WOT setup flag is OFF, that is, if the throttle opening is set to WOT with an acceleration request recognized in the preceding control sequence, step S132 is performed to judge whether the accelerator opening ACC is larger than the reference opening. If the accelerator opening ACC is not larger than the reference opening, step S134 is performed to set the throttle opening to the target opening in accordance with an intake air amount according to the engine speed NE and target torque TRtg. Step S136 is then performed to set the ignition timing to MBT according to the intake air amount and engine speed NE. Subsequently, step S138 is performed to turn OFF the WOT setup flag. This process then terminates temporarily.

If, on the other hand, the accelerator opening ACC is found to be larger than the reference opening, step S140 is performed to judge whether the accelerator opening ACC is larger than the reference opening for a period of longer than reference time. In other words, step S140 is performed to judge whether the elapsed time after the reference opening is reached by the accelerator opening is longer than the reference time.

If the judgment result obtained in step S140 does not indicate that the accelerator opening is larger than the reference opening for a period of longer than the reference time, steps S124 to S130 are performed in the same manner as described above. More specifically, step S124 is performed to calculate the torque TRmax that is generated when the ignition timing is MBT at the current engine speed NE and WOT intake air amount while the accelerator opening is WOT. Step S126 is then performed to calculate the torque difference TRD. Next, step S128 is performed to determine the ignition timing retard amount ΔT in accordance with the torque difference TRD. Step S130 is then performed to set the ignition timing Twot. Subsequently, this process terminates temporarily.

If, on the other hand, the judgment result obtained in step S140 indicates that the accelerator opening is larger than the reference opening for a period of longer than the reference time, step S142 is performed to set the throttle opening to the target opening. When the target opening is to be determined, a necessary intake air amount is first determined in accordance with the current engine speed NE and target torque TRtg. A throttle opening required for taking in the necessary amount of intake air is then determined as the target opening.

Next, step S144 is performed to estimate the amount of air GAs actually supplied into the cylinder 12. This air amount GAs is estimated in accordance with a map that indicates changes in the amount of air actually supplied into the cylinder 12 after the throttle opening is changed from WOT to the target opening. Next, step S146 is performed to set the ignition timing Ts. The ignition timing Ts is set to an ignition timing that is necessary for generating the target torque TRtg when the estimated amount of air GAs is supplied to the cylinder 12. More specifically, the ignition timing Ts is set as an ignition timing that is necessary for generating the target torque TRtg in accordance with the estimated air amount GAs and engine speed NE. Here, the throttle opening is changed from WOT to the target opening; therefore, the air amount GAs gradually decreases. Thus, it is believed that the ignition timing Ts set as described above is advanced from the previous ignition timing.

Next, step S148 is performed to judge whether the set ignition timing is advanced from MBT. If the obtained ignition timing Ts is not advanced from MBT, the ignition timing Ts is set to an ignition timing Ts according to the air amount GAs that was set in step S144. This process then terminates temporarily.

If, on the other hand, the judgment result obtained in step S148 indicates that the ignition timing is advanced from MBT, the estimated air amount GAs is considered to be in agreement with the target intake air amount according to the throttle opening. Therefore, step S150 is performed to set the ignition timing to MBT in order to generate the target torque TRtg in accordance with the intake air amount. Subsequently, step S152 is performed to turn OFF the WOT setup flag. When the WOT setup flag is turned OFF, the operation is controlled normally in response to the acceleration request detected in step S114. It indicates the end of a transition from a controlled state where the generated torque is controlled in accordance with ignition timing while the throttle opening is WOT to a normal operating state where the ignition timing is MBT.

As described above, the present embodiment immediately sets the throttle opening to WOT when a torque increase above the reference level is requested. Therefore, when an acceleration request or other torque increase request is received, the present embodiment immediately sets the throttle opening to WOT without calculating the throttle opening. This makes it possible to reduce throttle opening computation load and allow the maximum amount of intake air to flow inward, thereby causing the cylinder 12 to take in a necessary amount of air at an earlier stage. Therefore, a delay in the response to a driver's request, which arises out of an air intake lag, can be reduced. Further, ignition timing retard control is exercised to generate a target torque according to the acceleration request. Ignition timing can be directly controlled as the ECU 40 directly controls the timing of ignition by the ignition plug 20 positioned in the cylinder 12. Consequently, control can be exercised in accordance with calculated ignition timing without causing a response lag. As a result, torque can be instantly generated in accordance with a driver's request.

Further, if the accelerator opening continues to be larger than the reference opening, the present embodiment switches back to the target throttle opening from the WOT throttle opening and advances the ignition timing to MBT. This makes it possible to conduct a fuel-efficient operation. Consequently, fuel efficiency deterioration can be avoided while maintaining high responsiveness to an acceleration request. Further, when the throttle opening is to be changed from WOT to the reference opening, control is exercised to gradually advance the ignition timing while selecting an ignition timing for generating the target torque TRtg at an estimated amount of air GAs that would be actually supplied into the cylinder 12. This makes it possible to suppress torque fluctuations that may occur during a transition from a WOT throttle state to a fuel-efficient operation state.

It is assumed that the present embodiment sets the throttle opening to WOT when the amount of change in the accelerator opening is larger than the reference change amount. However, the present invention is not limited to the use of such a method. The throttle opening may be any throttle opening that is larger than a throttle opening (target opening) determined in accordance with a target torque. Even when such a throttle opening is used, a certain response lag can be resolved.

It is also assumed that the present embodiment sets the ignition timing for the use of a WOT throttle opening in accordance with the target torque TRtg and the intake air amount prevailing when the throttle opening is WOT. However, the present invention is not limited to the use of such a method. For example, an alternative would be to set the throttle opening to WOT, store in advance a map for estimating a change in the amount of air actually supplied into the cylinder 12, estimate the amount of air taken into the cylinder 12 in accordance with the map, and set the ignition timing in accordance with the estimated air amount.

Further, it is assumed that the present embodiment sets the reference change amount for the accelerator opening, which is used as a criterion for judging whether or not to use a WOT throttle opening, in accordance with the accelerator opening ACC. However, the present invention is not limited to the use of such a method. For example, an alternative would be to use the same reference change amount at all times.

Furthermore, it is assumed that the present embodiment calculates the ignition timing in accordance with an actually estimated change in the air amount GAs and exercises control to gradually advance the ignition timing to MBT. However, the present invention is not limited to the use of such a method. An alternative would be to exercise control to gradually advance the ignition timing in units of a fixed angle for each cycle until it reverts to MBT. In such an instance, too, the advance amount may be predetermined in accordance with a change in the amount of air GAs actually taken into the cylinder 12, which is predicted in accordance with a change in the throttle opening. This makes it possible to reduce torque fluctuations to a certain extent and advance the ignition timing to MBT while suppressing the occurrence of vibration. Further, the present invention is not limited to a situation where the ignition timing is gradually changed. If, for instance, an instant response is requested, the ignition timing may be immediately advanced to MBT or other appropriate ignition timing.

Moreover, it is assumed that the present embodiment sets the ignition timing to MBT after the throttle opening is changed from WOT to a target opening. More specifically, the present embodiment uses an MBT ignition timing as a reference ignition timing to obtain optimum fuel efficiency and output in accordance with an intake air amount. However, the present invention does not necessarily use the MBT ignition timing as the reference ignition timing. Alternatively, a preselected another ignition timing may be controlled in accordance with a determined ignition timing retard amount.

Even when the number, quantity, amount, range, or other numerical attribute of an element is mentioned in the above description of an embodiment, the present invention is not limited to the mentioned numerical attribute unless it is expressly stated or theoretically defined. Further, structures and steps of methods described in conjunction with the present embodiment are not necessarily essential to the present invention unless they are expressly stated or theoretically defined.

The features and the advantages of the present invention as described above may be summarized as follows.

According to one aspect of the present invention, when the accelerator opening change amount is judged to be greater than the reference change amount, the present invention preselects the large throttle opening that is a throttle valve opening larger than the target opening, which is defined in accordance with an intake air amount necessary for generating the target torque. Therefore, even when the amount of change in the target torque large, a necessary amount of intake air can be promptly taken into a cylinder. This makes it possible to minimize the delay in the intake air supply to the cylinder and generate the necessary torque instantly. In this instance, the ignition timing is set in accordance with the preselected large throttle opening so as to generate the target torque. Therefore, even when the intake air amount is larger than necessary due to the use of the large throttle opening, torque generation can be accomplished in accordance with the target torque.

According to another aspect of the present invention when the accelerator opening change amount is judged to be greater than the reference change amount, the present invention sets the throttle opening to the control maximum opening. Therefore, when the amount of increase in the target torque is large, it is possible to reduce throttle opening computation load and immediately create a state where the maximum possible amount of intake air can be taken in. Thus, a larger amount of intake air than necessary for generating the target torque can be taken into a cylinder with increased promptness. Consequently, required torque can be immediately generated in accordance with a request for target torque increase.

According to another aspect of the present invention, the reference change amount is set, which is used to judge the accelerator opening change amount, in accordance with a detected accelerator opening. Therefore, when the amount of target torque increase is large, control can be exercised to provide a large throttle opening without fail by making use of the fact that the amount of target torque change relative to the amount of accelerator opening change varies with the accelerator opening.

According to another aspect of the present invention, when the period of time during which the accelerator opening is larger than the reference opening is longer than the reference time, the present invention preselects the target opening, which is appropriate for the intake air amount necessary for generating the target torque, as the opening of the throttle valve. When the throttle opening is the target opening, the fourth aspect of the present invention preselects the target ignition timing for generating the target torque as the ignition timing. This makes it possible to switch to a fuel-efficient operating state for fuel-saving purposes when the accelerator opening continues to be large.

According to another aspect of the present invention, the present invention estimates the amount of air to be actually supplied to the cylinder after the opening of the throttle valve is controlled to agree with the target opening, and preselects an ignition timing for generating the target torque while the estimated amount of air is supplied. Therefore, it is possible to reduce a torque change that occurs before the ignition timing advances to the target ignition timing.

According to another aspect of the present invention, the present invention advances the ignition timing in units of a predetermined angle until the target ignition timing is reached. This makes it possible to reduce a torque change that occurs before the ignition timing advances to the target ignition timing.

Obviously many modifications and variations of the present invention are possible in the light of the above teachings. It is therefore to be understood that within the scope of the appended claims the invention may by practiced otherwise than as specifically described.

1. A method for controlling an internal combustion engine, comprising:
detecting an accelerator opening;
judging whether a change in the accelerator opening is greater than a reference change amount;
calculating a target torque in accordance with the accelerator opening;
when a change in the accelerator opening is judged to be greater than the reference change amount, setting a large throttle opening for a throttle valve positioned in an intake path of an internal combustion engine, the large throttle opening being larger than a target opening that is selected in accordance with an intake air amount necessary for the generation of the target torque; and
setting an ignition timing for an ignition plug positioned in a cylinder of the internal combustion engine, wherein the ignition timing agrees with the timing for generating the target torque while the large throttle opening is provided.

2. The method for controlling an internal combustion engine control according to claim 1, wherein the large throttle opening is used as a control maximum opening.

3. The method for controlling an internal combustion engine according to claim 1, further comprising:
setting the reference change amount in accordance with the accelerator opening.

4. The method for controlling an internal combustion engine according to claim 1, further comprising:
whether the period of time during which the accelerator opening is larger than a reference opening is longer than reference time;
when the period of time during which the accelerator opening is larger than the reference opening is judged to be longer than the reference time, setting the target opening as the opening of the throttle valve; and
setting a target ignition timing for generating the target torque while the target opening is provided.

5. The method for controlling an internal combustion engine according to claim 4, further comprising:
estimating the amount of air to be actually supplied to the cylinder after the opening of the throttle valve is controlled to agree with the target opening;
setting an ignition timing for generating the target torque while the estimated amount of air is supplied; and
judging whether the set ignition timing has advanced to the target ignition timing;
wherein, when the set ignition timing advances to the target ignition timing, setting the target ignition timing as the ignition timing.

6. The method for controlling an internal combustion engine according to claim 4, further comprising:
after the opening of the throttle valve is controlled to agree with the target opening, setting an ignition timing that has advanced by a certain angle from the current ignition timing; and
judging whether the advanced ignition timing has advanced to the target ignition timing;
wherein, when the advanced ignition timing advances to the target ignition timing, setting the target ignition timing as the ignition timing.

7. The method for controlling an internal combustion engine according to claim 2, further comprising:
exercising control to obtain a preset opening of the throttle valve; and
exercising control to provide a preset ignition timing for the ignition plug.

8. The method for controlling an internal combustion engine according to claim 2, further comprising:
setting the reference change amount in accordance with the accelerator opening.

9. The method for controlling an internal combustion engine according to claim 2, further comprising:
judging whether the period of time during which the accelerator opening is larger than a reference opening is longer than reference time;
when the period of time during which the accelerator opening is larger than the reference opening is judged to be longer than the reference time, setting the target opening as the opening of the throttle valve; and
setting a target ignition timing for generating the target torque while the target opening is provided.

10. The method for controlling an internal combustion engine according to claim 9, further comprising:
estimating the amount of air to be actually supplied to the cylinder after the opening of the throttle valve is controlled to agree with the target opening;
setting an ignition timing for generating the target torque while the estimated amount of air is supplied; and
judging whether the set ignition timing has advanced to the target ignition timing;
wherein, when the set ignition timing advances to the target ignition timing, setting the target ignition timing as the ignition timing.

11. The method for controlling an internal combustion engine according to claim 9, further comprising:
after the opening of the throttle valve is controlled to agree with the target opening, setting an ignition timing that has advanced by a certain angle from the current ignition timing; and
judging whether the advanced ignition timing has advanced to the target ignition timing;
wherein, when the advanced ignition timing advances to the target ignition timing, setting the target ignition timing as the ignition timing.

12. The method for controlling an internal combustion engine according to claim 2, further comprising:
exercising control to obtain a preset opening of the throttle valve; and
exercising control to provide a preset ignition timing for the ignition plug.

13. (canceled)

14. The method for controlling an internal combustion engine according to claim 1, wherein the ignition timing is retarded.

15. The method for controlling an internal combustion engine according to claim 14, wherein the ignition timing is retarded in accordance with a map that uses a torque difference and a load factor as parameters.
